(19) United States
(12) Patent Application Publication
(10) Pub. No.: US 2013/0311356 A1
(43) Pub. Date: Nov. 21, 2013

(54) Secure File Transfer with Electronic Payment Integration

(71) Applicants: William J. Ho, Carlisle, MA (US); Sharif Mustafizur Rahman, Fremont, CA (US)

(72) Inventors: William J. Ho, Carlisle, MA (US); Sharif Mustafizur Rahman, Fremont, CA (US)

(21) Appl. No.: 13/472,233

(22) Filed: May 15, 2012

(51) Int. Cl. G06Q 40/00; G06F 15/16

(52) U.S. Cl. 705/39

(57) ABSTRACT

A system for securely transferring an electronic package from one user to another includes a mechanism for requiring payment from the recipient of an electronic package before the recipient is permitted to receive the package. The sender of an electronic package may specify one or more files to be included in the package, one or more recipients of the package, and an amount of a required payment. Each recipient is notified of the electronic package and prompted to provide payment. The system permits each recipient to download the electronic package only if that recipient provides the required payment. The sender may specify a different payment amount for each recipient. The sender may add, delete, and modify files within the package over time. When a recipient downloads the package, the files that are within the package at that time are provided to the recipient.

### BACKGROUND

Computer users often want or need to transfer files to each other. Users often transfer files using technologies, such as the File Transfer Protocol (FTP) or email attachments, that have a variety of drawbacks. For example, both FTP and email attachments lack encryption and other security features that are required in many contexts. As another example, users often desire to transfer files that are too large to be delivered as email attachments. As yet another example, transferring files via FTP typically requires a high degree of sophistication on the part of the sender and recipient, making FTP unsuitable for many business environments.

In response to these and other drawbacks of common techniques for transferring electronic files over networks, various improved file transfer systems have been developed. For example, Biscom Inc. of Chelmsford, Mass. offers the Biscom Delivery Server (BDS) and related products for transferring files securely over the Internet and other networks. BDS enables files of any size and type to be transmitted easily and securely over the Internet and other networks. Examples of other file transfer systems are Box.net and DropBox.

### SUMMARY

A system for securely transferring an electronic package from one user to another includes a mechanism for requiring payment from the recipient of an electronic package before the recipient is permitted to receive the package. The sender of an electronic package may specify one or more files to be included in the package, one or more recipients of the package, and an amount of a required payment. Each recipient is notified of the electronic package and prompted to provide payment. The system permits each recipient to download the electronic package only if that recipient provides the required payment. The sender may specify a different payment amount for each recipient. The sender may add, delete, and modify files within the package over time. When a recipient downloads the package, the files that are within the package at that time are provided to the recipient.

For example, one embodiment of the present invention is directed to a method comprising: (A) receiving, from a first sender, electronic transmission definition data representing an original electronic transmission, the electronic transmission definition data comprising: (A)(1) a first recipient identifier specifying a first recipient of the original electronic transmission; (A)(2) original message data; and (A)(3) first payment data representing a first required payment amount; (B) receiving, from the first recipient, first payment data; (C) attempting to obtain, based on the first payment data, a first payment in an amount equal to the first required payment amount; and (D) making the original message data available to the first recipient only if the attempt to obtain the first payment from the first recipient succeeds.

Other features and advantages of various aspects and embodiments of the present invention will become apparent from the following description and from the claims.

### BRIEF DESCRIPTION OF THE DRAWINGS

FIG. 1A is a dataflow diagram of a system for uploading packages to be transmitted to recipients according to one embodiment of the present invention;

FIG. 1B is a dataflow diagram of a system for uploading envelopes to be transmitted to recipients according to one embodiment of the present invention;

FIG. 2A is a flowchart of a method performed by the system of FIG. 1A according to one embodiment of the present invention;

FIG. 2B is a flowchart of a method performed by the system of FIG. 1B according to one embodiment of the present invention;

FIG. 3 is a dataflow diagram of a system for transmitting packages securely to recipients and for requiring payments by those recipients according to one embodiment of the present invention; and

FIG. 4 is a flowchart of a method performed by the system of FIG. 3 according to one embodiment of the present invention.

### DETAILED DESCRIPTION

Embodiments of the present invention are directed to a system for securely transferring an electronic package from one user to another includes a mechanism for requiring payment from the recipient of an electronic package before the recipient is permitted to receive the package. More specifically, the sender of an electronic package may specify one or more files to be included in the package, one or more recipients of the package, and an amount of a required payment. Each recipient is notified of the electronic package and prompted to provide payment. The system permits each recipient to download the electronic package only if that recipient provides the required payment. The sender may specify a different payment amount for each recipient. The sender may add, delete, and modify files within the package over time. When a recipient downloads the package, the files that are within the package at that time are provided to the recipient.

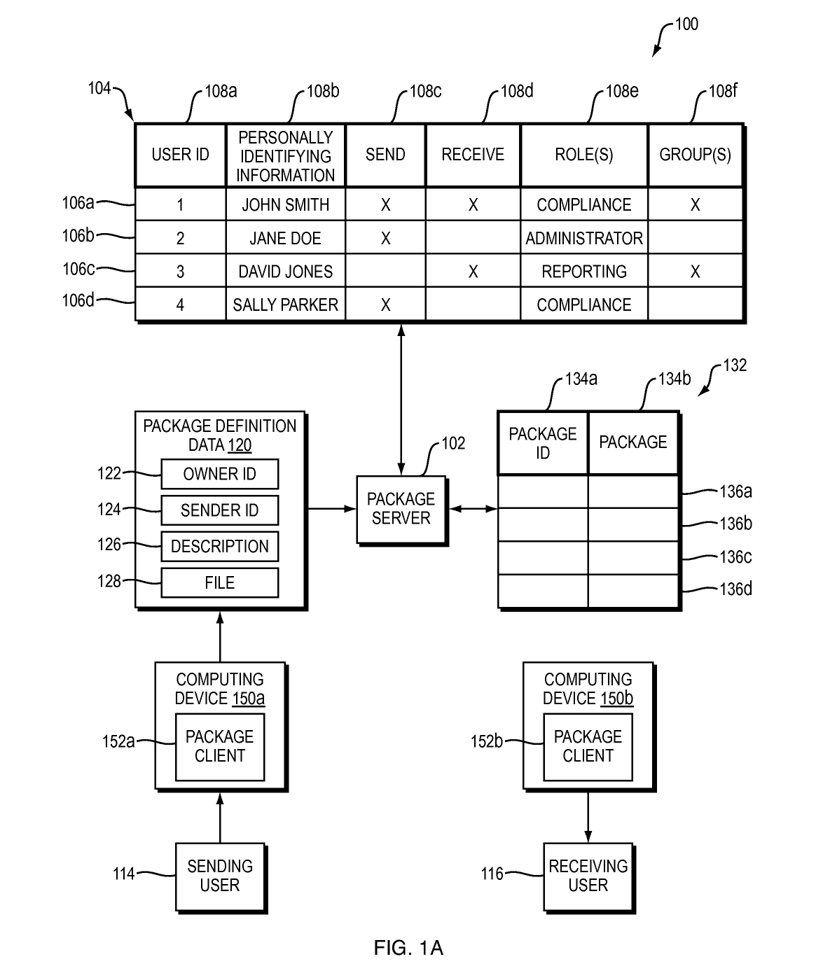

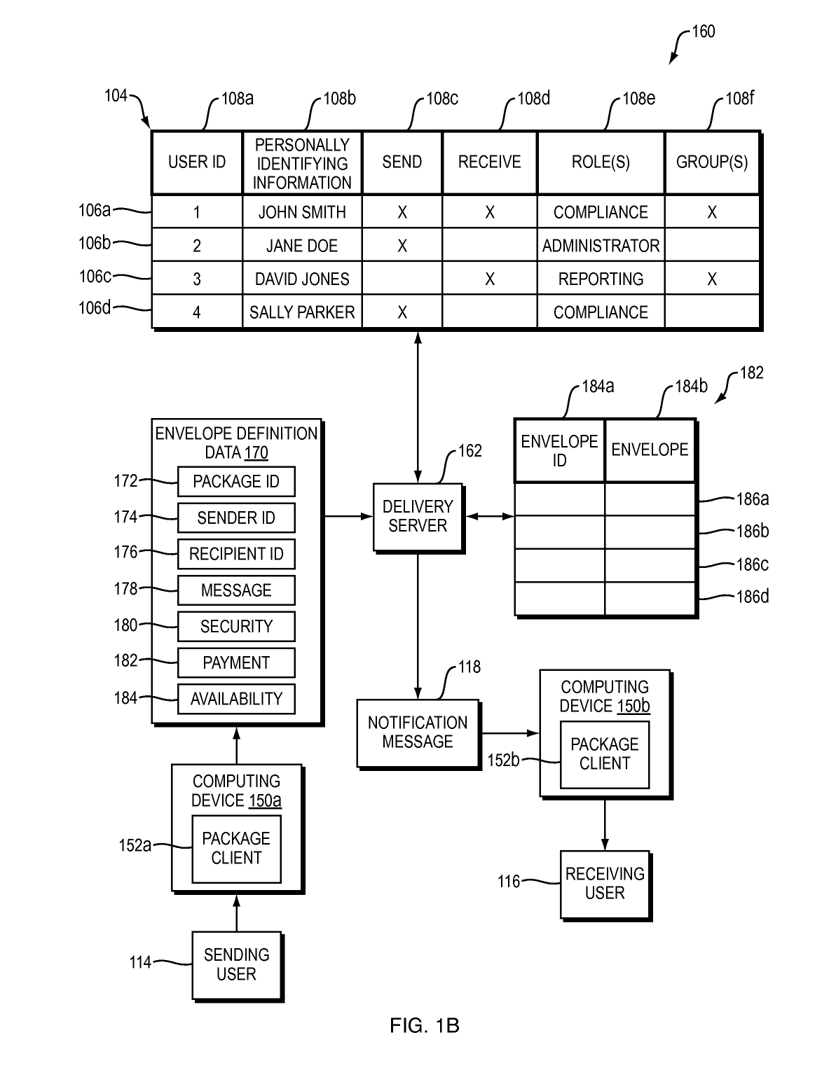

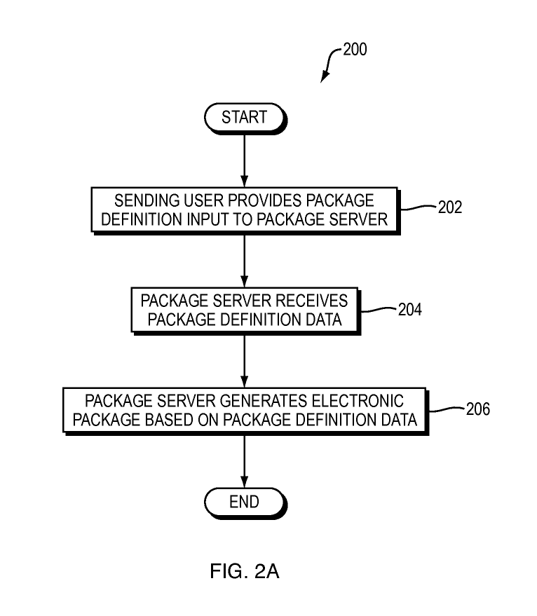

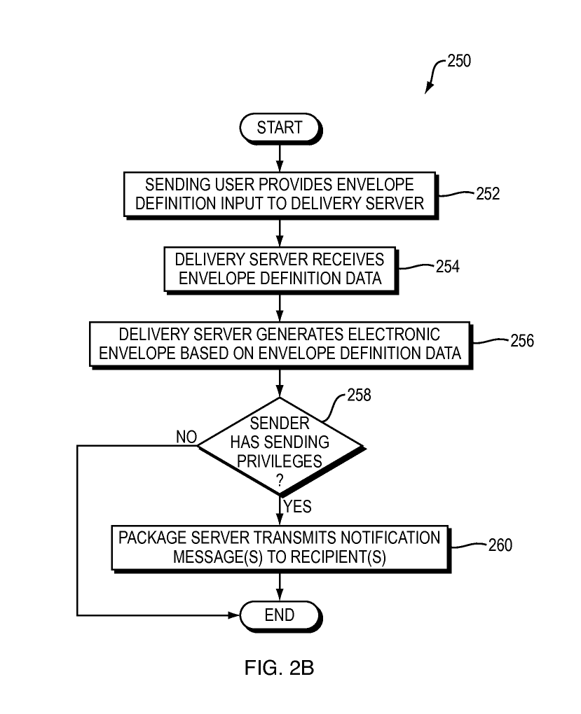

Having generally described various features of embodiments of the present invention, certain embodiments of the present invention will now be described in more detail. Referring to FIG. 1A, a dataflow diagram is shown of a system 100 for transmitting electronic packages according to one embodiment of the present invention. Referring to FIG. 2A, a flowchart is shown of a method 200 performed by the system 100 of FIG. 1A according to one embodiment of the present invention.

The electronic package transmission system 100 includes an electronic package server 102. The electronic package server 102 may include, for example, hardware, software installed on a computing device, or a combination thereof. As will be described in more detail below, the package server 102 may perform a variety of functions that enable users of the system 100 to transmit electronic packages to each other. In one embodiment of the present invention, the package server 102 is implemented using a Biscom Delivery Server (BDS). More generally, however, the package server 102 may be any kind of server that is capable of performing the functions disclosed herein.

For example, the package server 102 may be any kind of server that is capable of creating, modifying, and/or transmitting “electronic packages,” as that term is used herein. An electronic package may, for example, include one or more files of any type or combination of types (such as word processing documents, spreadsheets, Adobe Portable Document Format (PDF) documents, audio files, video files, executable files, or compressed files (e.g., Zip files)). As another example, an electronic package may be implemented as or contain one or more electronic messages, such as fax messages, email messages, text messages, and audio messages.

In certain embodiments of the present invention, an electronic package may be transmitted using an electronic envelope. For example, referring to FIG. 1B, a dataflow diagram is shown of a system 160 which contains a delivery server 162 for transmitting electronic envelopes. As will be described in more detail below, an envelope specifies delivery data for transmitting data in an electronic package. A single package may be transmitted multiple times via multiple envelopes using different delivery data each time. The delivery server 162 may transmit (i.e., send and/or receive) electronic envelopes and other messages over any kind of network, such as the public Internet or a private intranet. Although no network is shown in FIG. 1A or 1B, it should be understood that any transmission of electronic envelopes and other messages described herein may occur over any such network. Furthermore, the division of data into electronic packages and electronic envelopes is merely an example and does not constitute a limitation of the present invention. Alternatively, for example, all data necessary to transmit data securely may be contained within a single data structure, such as an electronic package, in which case any description herein of electronic envelopes may apply equally to electronic packages, and vice versa. Furthermore, any reference herein to sending or receiving “packages” should be understood to apply equally to sending or receiving envelopes, and vice versa.

Users of the system 100 may be required to have accounts in the system 100 to transmit (send and/or receive) envelopes using the system 100. To this end, the system 100 includes user account data 104 representing accounts of users of the system 100. The terms “users of the system 100,” “users enrolled in the system 100,” and “users having accounts in the system 100” are used interchangeably herein.

The user account data 104 may be implemented using one or more database tables of the kind shown in FIG. 1A. In the particular example shown in FIG. 1A, the user account data 104 includes four rows 106a-d, each of which represents a distinct user account corresponding to a distinct user of the system 100. In practice, the user account data 104 may include any number of rows 106a-d representing any number of user accounts.

User account data 104 includes several columns 108a-e, corresponding to distinct data fields (or groups of fields). In the particular example shown in FIG. 1A, the user account data 104 includes the following fields:
User identifier (ID) 108a: The value of this field represents a unique ID of the corresponding user. Such a unique ID may, for example, be an email address of the user, a telephone number of the user, or a text string (such as a sequence of alphanumeric characters) uniquely identifying the user.
Personal identifying information 108b: The value of this field may include any one or more of the following: real name, mailing address, telephone number, username, password, and billing information of the corresponding user.
Send privileges 108c: The value of this field indicates whether the corresponding user is authorized to send packages using the system 100.
Receive privileges 108d: The value of this field indicates whether the corresponding user is authorized to receive packages using the system 100.
Role 108e: The value of this field indicates the role(s), if any, of the corresponding user. Examples of roles include administrator, compliance officer, and reporter. Each role may be associated with different privileges within the system. For example, administrators may be allowed to perform any function within the system, while reporters may be allowed to generate reports within the system but not create or modify packages or transmit envelopes.
Group 108f: The value of this field indicates the group(s), if any, to which the corresponding user belongs. The system 100 may store data associated with individual groups, such as the privileges associated with each group, in a separate data structure (not shown). Data associated with a group may specify, for example, the send privileges, receive privileges, and roles associated with the group. Assigning an individual user to a particular group may cause that user to inherit the send privileges, receive privileges, and roles associated with the group. Conversely, removing an individual user from a particular group may cause that user to lose the send privileges, receive privileges, and roles associated with the group. Groups, therefore, facilitate the process of assigning privileges to users and of stripping privileges from users.

The particular fields 108a-d shown in FIG. 1A are merely examples and do not constitute limitations of the present invention. More generally, the user account data 104 may include fields not shown in FIG. 1A, and need not include all of the fields shown in FIG. 1A. Furthermore, the user account data 104 may be distributed among multiple tables, and may be implemented using data structures other than tables.

The rows 106a-d of the user account data 104 have been filled with certain example values in FIG. 1A for purposes of illustration. For example, the User ID fields 108a of rows 106a-d have been filled with the values 1, 2, 3, and 4, respectively, to illustrate that each such value is unique within the User ID column 108a.

In the particular example of FIG. 1A, the user corresponding to row 106a is authorized to send packages, and receive packages, as indicated by the values of columns 108c and 108d in row 106a. The user corresponding to row 106b is authorized to send packages, but not to receive message, as indicated by the values of columns 108c and 108d in row 106b. The user corresponding to row 106c is authorized to receive packages, but not to send packages, as indicated by the values of columns 108c and 108d in row 106c. Finally, the user corresponding to row 106d is authorized to send packages, but not to receive packages, as indicated by the values of columns 108c and 108d in row 106d. These particular field values are shown in FIG. 1A merely for purposes of example and do not constitute limitations of the present invention.

The system 100 may only permit users who are enrolled in the system 100 to send packages. Alternatively, the system 100 may permit non-enrolled users to send packages. Similarly, the system 100 may only permit users who are enrolled in the system 100 to receive packages. Alternatively, the system 100 may permit non-enrolled users to receive packages. Such features may be combined with each other in any way. For example, the system 100 may only permit users who are enrolled in the system 100 to send packages, but may permit non-enrolled users to receive packages.

FIG. 1A shows, for purposes of example, a “sending user” 114 (also referred to as a “sender”) and a “receiving user” 116 (also referred to as a “recipient”). More specifically, in the example of FIG. 1A, the single sender 114 uses the system 100 to transmit an electronic package to the single recipient 116. This is merely an example, however. More generally, any number of senders may transmit an electronic package to any number of recipients. Furthermore, the sender 114 may, but need not, be a human user. Alternatively, for example, the sender 114 may be a computer program, computer hardware, a fax machine, an email server, or any combination thereof.

The system 100 may include or otherwise interact with a payment service 112. The payment service 112 may include, for example, hardware, software installed on a computing device, or a combination thereof. The payment service 112 may manage the receipt and processing of payments from recipients to senders. For example, in FIG. 1A, the payment service 112 may manage the receipt of a payment recipient 116 to sender 114. Although the payment service 112 is shown as a distinct component in FIG. 1A, alternatively the payment service 112 may be included within or otherwise integrated with the package server 102. Alternatively, for example, and as described in more detail below, the payment server 112 may be external to the system 100 and interact with the system 100 through an API or other interface.

The sender 114 may use a computing device 150a to perform a variety of functions within the system 100. The computing device 150a may be any of a variety of kinds of computing devices, such as a desktop or laptop computer, personal digital assistant (PDA), smartphone, tablet computer, fax machine, scanner, multifunction device, or any combination thereof. Such a computing device may include any kind of input component(s) (such as keyboards, mice, trackpads, touchpads, touch screens, and microphones). Therefore, it should be understood that any input described herein as being provided by the sender 114 to the system 100 may be provided by the sender 114 to the system 100 using any such input component(s). Similarly, such a computing device may include any kind of output component(s) (such as monitors, touchscreens, and/or speakers). Therefore, it should be understood that any output described herein as being provided by the system 100 to the sender 114 may be provided by the system 100 to the sender 114 using any such output component(s).

The computing device 150a may include a package client 152a, which may be any software and/or other component for interfacing with the package server 102 and/or payment service 112. For example, the package server 102 may be configured to communicate using a particular communications protocol (such as HTTPS), in which case the package client 152a may be configured to communicate with the package server 102 using the particular communications protocol required by the package server 102.

In certain embodiments of the present invention, computing devices that lack a package client that is capable of communicating using the particular communications protocol required by the package server 102 are incapable of communicating with the package server 102. In other embodiments of the present invention, computing devices lacking such a package client may nonetheless communicate with the package server 102, such as by using a standard web browser, in which case the functions performed by the package server 102 and/or the invitation server 112 may be performed over the web. Therefore, any description herein of functions performed by the package clients 152a-b should be understood to be equally applicable to web browsers and other components for performing the same functions.

The recipient 116 may use a computing device 150b to perform a variety of functions within the system 100. The computing device 150b may be any of the same kinds of computing devices as the computing device 150a used by the sender 114. Therefore, it should be understood that any input described herein as being provided by the recipient 116 to the system 100 may be provided by the recipient 116 to the system 300 using input component(s) of the computing device 150b, and that any output described herein as being provided by the system 100 to the recipient 116 may be provided by the system 300 to the recipient 116 using any output component(s) of the computing device 150b. The recipient's computing device 150b may include a package client 152b, which may be the same as or similar to the package client 152a that is installed on the computing device 150a of the sender 114.

Examples of techniques will now be described that may be used by the systems 100 and 160 of FIGS. 1A and 1B, respectively, to create an electronic package and to securely transmit one or more envelopes containing package data from the sender 114 to the recipient 116, and for requiring and receiving a sender-specified payment from the recipient 116 before permitting the recipient 116 to receive the electronic envelope.

The sender 114 may provide package definition data 120 to the package server 102, such as by providing input to the package client 152a, which then transmits data representing the package definition data 120 to the package server 102 (FIG. 2A, operation 202). In general, the purpose of the package definition data 120 is to define parameters of an electronic package to be created by the package server 102.

The sender 114 may provide the package definition data 120 to the package server 102 in any of a variety of ways. For example, the sender 114 may use the package client 152a to log into the sender's account within the system 100. The package client 152a may provide a user interface that prompts the sender 114 to provide credentials for the sender's account, such as a user name and password. The sender 114 may, in response, provide a username and password to the package client 152a, which may transmit the username and password to the package server 102. The package server 102 may then determine (by reference to the user account data 104) whether the username and password provided by the sender 114 authenticate the sender 114 as a user of the system 100. If the package server 102 successfully authenticates the sender 114, then the package server 102 provides the sender 114 with access to the sender's account (within the user account data). Otherwise, the package server 102 denies access to the sender 114.

The package client 152a may provide the sender 114 with a graphical user interface (GUI) through which the sender 114 may provide any of a variety of inputs. For example, the GUI may include a “send package” button. The sender 114 may click the “send package” button to initiate the process of sending a package to the recipient 116. After clicking on the “send package” button, the package client 152a may prompt the sender 114 to provide input for generating data within the package definition data 120. The sender 114 may provide such input to the package client 152a, which may use such input to generate and transmit the package definition data 120 to the package server 102. Note that the sender 114 may, for example, provide input that specifies the package definition data 120 by inputting such data manually (e.g., by typing text for use as some or all of the package definition data 120) and/or by selecting existing data for use in the package definition data 120 (e.g., by selecting files from a file system to be included in the package definition data 120, by scanning documents with a scanner, and/or by selecting one or more URLs or other pointers to data to be included in the package definition data 120).

The use of the package client 152a is described herein merely as an example of a mechanism that the system 100 may use to receive the package definition data 120 from the sender 114. Other mechanisms are also within the scope of the present invention. Alternatively, for example, the sender 114 may provide the package definition data 120 through a web-based portal or by transmitting an email message containing the package definition data 120 to the package server 102.

The package definition data 120 may include any of a variety of data, such as one or more of the following:
A set of owner identifiers (IDs) 122, which may contain one or more identifiers of one or more owners of the electronic package. An owner of a package has the right to perform any operation on a package, such as modifying it, deleting it, and sending envelopes based on it. Assume, for purposes of example, that in the system 100 of FIG. 1A, the sender 114 is the only owner of the package defined by the package definition data 120. In this case, the owner ID set 122 would contain only a single ID of the sender 114. Alternatively, however, multiple users may be senders of the same package, in which case the owner ID set 122 may include multiple sender IDs. An owner ID may be an ID of an individual user or an ID of a user group. Note that the identifier in the recipient ID set 122 may be of the same or different type than the identifiers 108a of users in the user account data 104.
A set of sender identifiers (IDs) 124, which may contain one or more identifiers of one or more users (individuals or groups) who have the right to send envelopes containing data from the electronic package. The inclusion of an ID in the sender ID set 124 only grants the corresponding user the right to send envelopes containing data from the electronic package, not the right to delete or modify the package. In the system 100 of FIG. 1A, in which there is only the single sender 114, the sender ID set 124 would contain only a single ID of the recipient sender 114. Alternatively, however, multiple users may have the right to send envelopes containing data from the same package, in which case the sender ID set 122 may include multiple sender IDs. The contents of the owner ID set 122 may be the same as or differ from the contents of the sender ID set 124. For example, the owner ID set 122 may contain user IDs that are not contained in the sender ID set. Note that the identifier in the recipient ID set 122 may be of the same or different type than the identifiers 108a of users in the user account data 104.
A description 126, which may be any description of the package represented by the package definition data 120. For example, the description may contain any one or more of the following: a narrative description of the package, one or more tags representing concepts related to the package, and one or more keywords representing information related to the package.
A set of files 128, which may contain zero or more files to be included in the package. The sender 114 may, for example, include zero files in the file set 128 if the sender 114 merely desires to transmit the message 124 securely to the recipient 116. The file set 128 may include any number of files of any type or combination of types. The file set 128 may also include metadata information associated with the files in the file set 128, such as any one or more of the following: filenames, creation dates, modification dates, creators, and file types. Such metadata information may, for example, be input manually by the sender 114 and/or obtained automatically by the system 100. Any reference herein to the files in the file set 128 or to the file set 128 itself should be understood to include any metadata contained within the file set 128.

Note that the package definition data 120 need not include all of the data listed above. For example, the package definition data 120 may omit the sender ID 122, in which case the package server 102 may ascertain the sender ID based on the identity of the sender 114. As another example, the package definition data 120 may omit the file set 128.

For ease of illustration and explanation, a single sender/owner 114 is shown in FIG. 1A. Therefore, it should be understood that the description herein may describe certain acts as being performed by the sender 114 by virtue of the status of the sender 114 as both a sender and an owner of the package data 120. If the sender 114 were only a sender and not also an owner of the package data 120, then it might be necessary for some of the acts described herein to be performed by a separate owner of the package data 120 rather than by the sender 114.

Once the sender 114 has provided the input necessary to generate the package definition data 120, the package server 102 receives the package definition data 120 from the sender's computing device 150a (FIG. 2A, operation 204). Next, the package server 120 generates an electronic package based on the package definition data 120 (FIG. 2A, operation 206). The package server 102 may, for example, store the package in a package store 132 associated with the package server 102. More generally, the package server 102 may store some or all of the package definition data 120, or data derived from the package definition data 120, in the package store 132.

For example, the package server 102 may associate a unique package identifier (ID) with the package definition data 120 that distinguishes the package definition data 120 from other package definition data provided by the sender 114 and/or other users of the system 100. More generally, each time the package server 102 receives package definition data, the package server 102 may assign a unique ID to that package definition data to distinguish it unambiguously from all other package definition data previously received by the package server 102.

Although the package store 132 is shown in FIG. 1A as being stored at or otherwise maintained by the package server 102, this is merely an example and not a limitation of the present invention. Alternatively, for example, the package client 152a may store the package store 132 locally (i.e., at the computing device 150a). Although only one package client 152a is shown in FIG. 1A, the system 100 may include multiple computing devices, each with its own package client. In this scenario, each such package client may maintain its own local queue for recording package definition data generated by the device on which the package client is installed. In contrast, in the embodiment of FIG. 1A, the package store 132 may include package definition transmitted by multiple package clients associated with multiple user accounts.

The package server 102 may create a record which contains both the package definition data 120 and its unique package ID, and then store such a record in the package store 132. Such a record may be referred to herein as a “package” or “package record.” For example, as shown in FIG. 1A, the package store 132 may contain package records 136a-d, each of which contains a unique package ID field 134a and package field 134b. Assume for purposes of example that the package store 132 is empty when the package server 102 receives the package definition data 120 from the sender 114. In this case, the package server 102 may store, in record 136a of the package store 132, the unique ID of the package definition data 120 in field 134a and a copy of the package definition data 120 (or a subset thereof (e.g., the message 178) or data derived from the package definition data 120) in field 134b of record 136a. The combination of package ID and package definition data stored in record 136a is one example of an “electronic package” as that term is used herein.

The package store 132 may take any form. For example, the package store 132 may be implemented as an array addressable by indices into the array. In general, the purpose of the package store 132 is to provide a means for storing electronic packages provided by senders so that such electronic packages may subsequently be modified by senders (such as by adding and/or removing files from them) and used to generate electronic envelopes to be transmitted to recipients. By storing a unique package ID in association with each package in the package store 132, the system 100 is able to identify and retrieve the package specified by any particular request from a sender or recipient. The package store 132 may therefore be implemented in any way that enables this purpose to be achieved.

Once a package has been created, any owner or sender of the package (such as sender 114) may send an envelope containing data from the package to one or more recipients (such as recipient 116). Referring to FIG. 1B, a system 160 may include a delivery server 162 for transmitting such envelopes. Although the delivery server 162 and package server 102 are illustrated as separate components in FIGS. 1A and 1B, one or more functions of the delivery server 162 and package server 102 may be combined together. More generally, one or more functions of the system 100 of FIG. 1A and the system 160 of FIG. 1B may be combined together.

Similarly, although the system 160 of FIG. 1B is illustrated as containing package clients 152a-b for interacting with delivery server 162, the system 160 may instead include delivery clients, in which case the package clients 152a-b of FIG. 1A may interact with the package server 102 of FIG. 1A, while the delivery clients may interact with the delivery server 162 of FIG. 1B. For ease of illustration and explanation, however, the package clients 152a-b will be described herein as interacting with the delivery server 162 of FIG. 1B.

Referring to FIG. 2B, a flowchart is shown of a method 250 that is performed by the system 160 of FIG. 2B according to one embodiment of the present invention to transmit an envelope from one or more senders to one or more recipients. A sender (such as sender 114) provides envelope definition input to the delivery server 162, such as by providing input to the package client 152a, which then transmits envelope definition data 170 to the delivery server 162 (FIG. 2B, operation 252). Note that although in the example of FIG. 1B, the owner/sender 114 who created the package 120 in FIG. 1A is the same user as the sender 114 who provides the envelope definition data 120 in FIG. 1B, this is merely an example and does not constitute a limitation of the present invention. Alternatively, for example, one user may create the package definition data 120 representing a package, and a different user may create the envelope definition data 120 for that package.

In general, the purpose of the envelope definition data 170 is to define parameters of an electronic envelope that contains data from a corresponding electronic package. The sender 114 may provide the envelope definition data 170 to the delivery server 162 in any of a variety of ways, such as any of the ways described above in connection with provision of the package definition data 120 to the package server 102 in FIG. 1A.

For example, the sender 114 may use the package client 152a to log into the sender's account within the system 160. The package client 152a may provide a user interface that prompts the sender 114 to provide credentials for the sender's account, such as a user name and password. The sender 114 may, in response, provide a username and password to the package client 152a, which may transmit the username and password to the delivery server 162. The deliver server 162 may then determine (by reference to the user account data 104) whether the username and password provided by the sender 114 authenticate the sender 114 as a user of the system 160. If the delivery server 162 successfully authenticates the sender 114, then the delivery server 102 provides the sender 114 with access to the sender's account (within the user account data 104). Otherwise, the delivery server 162 denies access to the sender 114.

The package client 152a may provide the sender 114 with a graphical user interface (GUI) through which the sender 114 may provide any of a variety of inputs. For example, the GUI may include a “send envelope” button. The sender 114 may click the “send envelope” button to initiate the process of sending an envelope containing a package to the recipient 116. After clicking on the “send envelope” button, the package client 152a may prompt the sender 114 to provide input for generating an envelope corresponding to an existing package (such as the package definition data 120 created in FIG. 1A). The sender 114 may provide such input to the package client 152a, which may use such input to generate and transmit envelope definition data 170 to the delivery server 162.

The envelope definition data 170 may include any of a variety of data, such as one or more of the following:
A package identifier 172, which identifies the package to which the envelope definition data 170 corresponds. In the process of inputting the envelope definition data 170, the system 160 may, for example, provide the sender 114 with a list of existing packages for which the sender 114 has “send” rights. The sender 114 may select one of these packages. The system 160 may copy the package ID (e.g., from package ID field 134a of the package's record in the package store 132) into the package ID field 172 of the envelope definition data 170, thereby creating a link from the envelope definition data 170 to the corresponding package.
A set of sender identifiers (IDs) 172, which may contain one or more identifiers of one or more senders (individuals or groups) of the electronic envelope. The system 160 may prohibit any user who is not in the sender ID list 124 of a package from being a sender of an envelope corresponding to that package.
A set of recipient identifiers (IDs) 176, which may contain one or more identifiers of one or more recipients (individuals or groups) of the electronic envelope. For example, in the system 160 of FIG. 1B, in which there is only the single recipient 116, the recipient ID set 176 would contain only a single ID of the recipient 116. If, however, the sender 114 desired to transmit the electronic envelope to multiple recipients, then the sender 114 could include multiple IDs in the recipient ID set 176, one for each such recipient. Note that the identifier in the recipient ID set 176 may be of the same or different type than the identifiers 108a of users in the user account data 104. One reason for this is that the recipient 116 may not have an account in the system 100 (i.e., in the user account data 104), and therefore may not have a unique user ID in the system 100 (i.e., in the user ID column 108a).
A secure message 178 to be delivered to the recipient(s) specified in the recipient ID field 176. Such a message may, for example, be a text message typed by the sender 114 when defining the envelope definition data 170. The message 178 is optional and may be empty or otherwise not included in the envelope definition data 170.
Security data 180, which may define one or more security tests that each of the recipients must pass in order to be granted access to the electronic envelope. The security data 180 may, for example, include a password or a question that must be answered by each recipient.
A set of payment amounts 182. In general, the payment amount set 182 represents the amount(s) of the payment(s) required to be made by the recipient(s) of the electronic envelope before the recipient(s) is/are permitted to receive the electronic envelope (particularly the secure message 178 and/or the files 128 from the corresponding package). The payment amount set 182 may include any number of payment amounts. For example, if there is one recipient, then the payment amount set 182 may include only a single payment amount associated with that recipient. As another example, if there are multiple recipients, the payment amount set 182 may include only a single payment amount associated with all of the recipients. As yet another example, if there are multiple recipients, the payment amount set 182 may include multiple payment amounts, each of which is associated with a distinct one of the recipients. If the payment amount associated with a recipient is zero or otherwise omitted, then the system 100 may not require any payment from that recipient before that recipient is permitted to receive the electronic package.
Availability data 184 that defines one or more of the following: (1) the earliest time at which the contents of the electronic envelope are to be made accessible to the recipient(s); and (2) the latest (expiration) time at which the contents of the electronic envelope are to be made accessible to the recipient(s).

Once the sender 114 has provided the input necessary to generate the envelope definition data 170, the envelope server 162 receives the envelope definition data 170 from the sender's computing device 150a (FIG. 2B, operation 254). Next, the envelope server 170 generates an electronic envelope based on the envelope definition data 170 (FIG. 2B, operation 256). The envelope server 162 may, for example, store the envelope in an envelope store 182 associated with the envelope server 162. More generally, the envelope server 162 may store some or all of the envelope definition data 170, or data derived from the envelope definition data 170, in the envelope store 182.

For example, the envelope server 162 may associate a unique envelope identifier (ID) with the envelope definition data 170 that distinguishes the envelope definition data 170 from other envelope definition data provided by the sender 114 and/or other users of the system 160. More generally, each time the envelope server 102 receives envelope definition data, the envelope server 102 may assign a unique ID to that envelope definition data to distinguish it unambiguously from all other envelope definition data previously received by the envelope server 102.

Although the package store 132 is shown in FIG. 1A as being stored at or otherwise maintained by the package server 102, this is merely an example and not a limitation of the present invention. Alternatively, for example, the package client 152a may store the envelope store 182 locally (i.e., at the computing device 150a).

The envelope server 102 may create a record which contains both the envelope definition data 170 and its unique envelope ID, and then store such a record in the envelope store 182. Such a record may be referred to herein as a “envelope” or “envelope record.” For example, as shown in FIG. 1B, the envelope store 182 may contain envelope records 186a-d, each of which contains a unique envelope ID field 184a and envelope field 184b. Assume for purposes of example that the envelope store 182 is empty when the delivery server 162 receives the envelope definition data 170 from the sender 114. In this case, the delivery server 162 may store, in record 186a of the envelope store 182, the unique ID of the envelope definition data 170 in field 184a and a copy of the envelope definition data 170 (or a subset thereof (e.g., the message 178) or data derived from the envelope definition data 170) in field 184b of record 186a. The combination of envelope ID and envelope definition data stored in record 186a is one example of an “electronic envelope” as that term is used herein. The envelope store 132 may take any of the forms described above for the package store 132 of FIG. 1A.

The delivery server 162 may permit the sender 114 to send the electronic envelope only if the corresponding package specifies that the sender 114 has “send” privileges for that package (as specified by the sender ID set 124 of the package). Therefore, as shown in FIG. 2B, the delivery server 162 may determine whether the sender 114 has “send” privileges for the corresponding package and only continue with the envelope transmission process of FIG. 2B if the sender 114 is determined to have such “send” privileges (FIG. 2B, operation 258). In other words, if the delivery server 162 determines that the sender 114 does not have “send” privileges for the corresponding package, then the delivery server 162 does not generate the envelope defined by the envelope definition data 170 and does not perform any of the remaining steps described below. The package client 152a may not even permit the sender 114 to provide the envelope definition data 170 to the delivery server 162 if the sender 114 is determined not to have “send” privileges.

In response to generating the electronic envelope 186a, the delivery server 162 may transmit a notification message 118 to each recipient of the electronic envelope 186a (FIG. 2B, operation 260). Note that the notification message 118 differs from the secure message 178 contained within the envelope 186a. The secure message 178 is transmitted securely to recipients as part of an envelope delivery. The secure message 178, therefore, is made available to a recipient only after the recipient has successfully authenticated himself to the system 160, and is transmitted to the recipient securely, whereas the notification message 118 is transmitted to the recipient before the recipient has authenticated himself to the system 160, and need not be transmitted to the recipient securely.

In the system 160 of FIG. 1B, there is only the single recipient 116, so only one notification message 118 is transmitted. The purpose of the notification message 118 is to notify the recipient 116 that the envelope 186a has been generated and is available for payment and subsequent pickup by the recipient 116. The notification message 118 may take any of a variety of forms. For example, the notification message 118 may be an email message, SMS message, notification (e.g., badge or banner), (or other type of message) containing a hyperlink that the recipient 116 may select to be taken to a web page through which the recipient 116 may make the requirement payment 130 and download the electronic package 136a that corresponds to the electronic envelope 186a (or portions thereof, such as the message 178 and/or files 128).

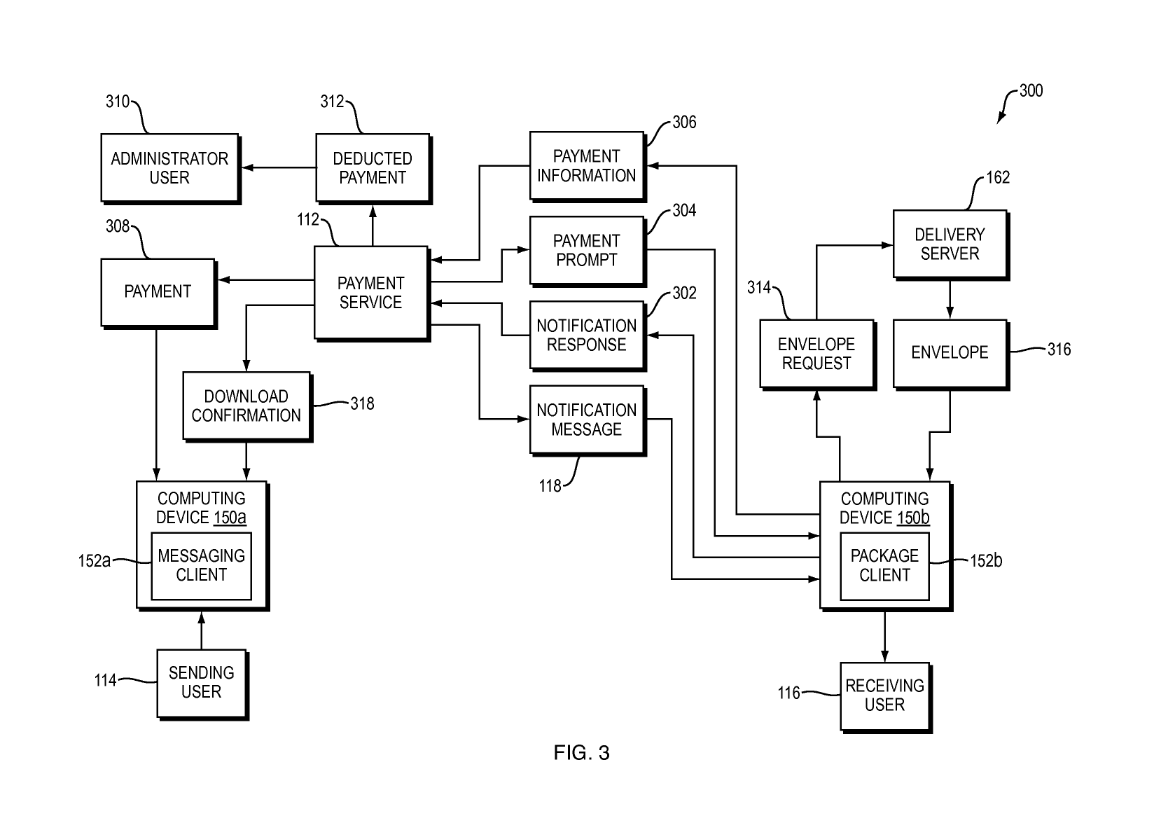

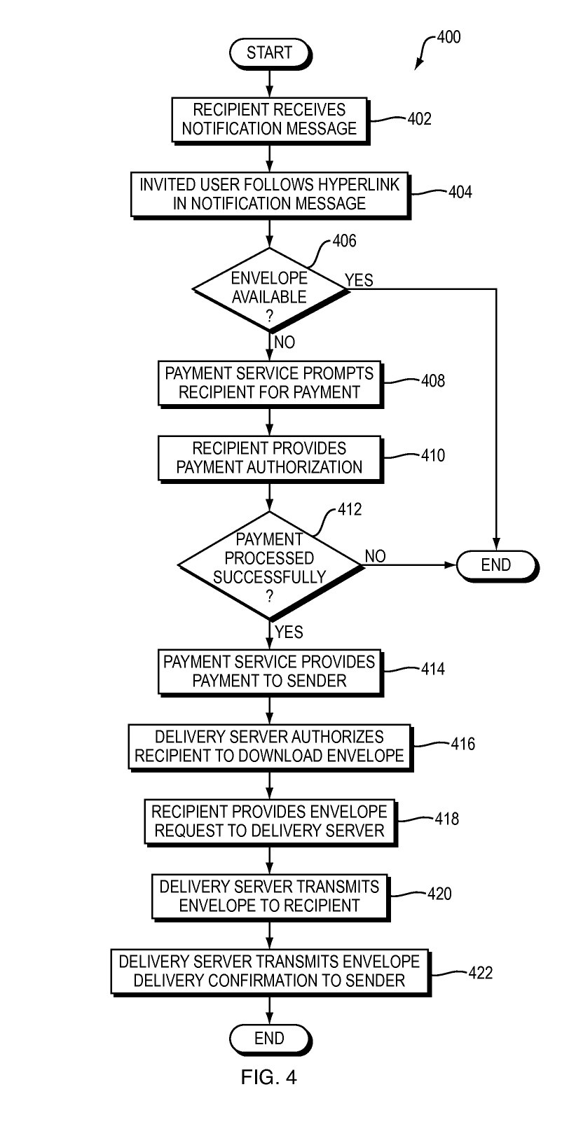

Referring to FIG. 3, a dataflow diagram is shown of a system 300 for enabling the recipient 116 to: (1) receive and respond to the notification message 118; (2) make the required payment 130 (if any); and (3) receive (e.g., download) the electronic envelope 186a (or portions thereof) transmitted by the sender 114 according to one embodiment of the present invention. Referring to FIG. 4, a flowchart is shown of a method 400 performed by the system 300 of FIG. 3 according to one embodiment of the present invention. Although the systems 100 (FIG. 1A), 160 (FIG. 1B), and 300 (FIG. 3) are illustrated as separate systems, they may be different parts of the same system or overlap in other ways. Therefore, any reference herein to the systems 100, 160, or 300 should be understood to refer to a system including any one or more of systems 100, 160, system 300.

Furthermore, any reference herein to transmitting, downloading, or otherwise providing the “electronic envelope” should be understood to refer to transmitting, downloading, or otherwise providing some or all of the electronic envelope and some or all of the electronic package that corresponds to the electronic envelope. For example, in the case of FIGS. 1A and 1B, transmitting the electronic envelope 186a may include transmitting data from the envelope definition data 170 (such as the secure message 178) and data from the corresponding package definition data 120 (such as the files 128).

The computing device 150b of the recipient 116 receives the notification message 118 (FIG. 4, operation 402). Assume for purposes of example that the notification message 118 takes the form of an email message. The recipient 116 may open such an email message, which may contain: (1) text describing the purpose of the notification message 118; and (2) instructions and a hyperlink for using the notification message 118 to make the required payment 130 and download the electronic envelope 186a.

The recipient 116 may click on the hyperlink or otherwise follow the instructions in the notification message 118 to initiate the payment and download process (FIG. 4, operation 404). More generally, the recipient 116 may take any appropriate action in response to the notification message 118 to initiate the payment and download process.

The target of the hyperlink in the notification message 118 may be a resource located at or otherwise served by the delivery server 162. Therefore, when the recipient 116 clicks on the hyperlink, the computing device 150b of the recipient 116 may transmit a request 302 to the delivery server 162 for the content addressed by the hyperlink. In response, the delivery server 162 may take any of a variety of actions.

For example, the delivery server 162 may determine whether the envelope associated with the notification message 118 is currently available, by reference to the availability field 184 of the envelope 186a from which the notification message 118 was generated (FIG. 4, operation 406). For example, the delivery server 162 may determine whether the current time is later than any first availability time specified by availability field 184 and whether the current time is earlier than any expiration time specified by the availability field 184. If the delivery server 162 determines that the envelope 186a has expired, then the method 400 terminates and the recipient 116 is prevented from continuing the payment and download process.

If the envelope 186a has not expired, then the delivery server 162 instruct the payment service 112 to attempt to obtain the required payment from the recipient 116. In response, the payment service 112 may provide a prompt 304 to the recipient 116 to make the required payment 130 (FIG. 4, operation 408). For example, the payment service 112 may cause the recipient's computing device 150b to display the amount of the required payment 130 to the recipient 116, along with user interface elements for enabling the recipient to make the payment via mechanisms such as credit card, debit card, wire transfer, payment service (e.g., PayPal), or ACH, in U.S. dollars or any other currency. In response, the recipient 116 may provide input 306 authorizing payment in the amount of the required payment 130 to be made to the sender 114 (FIG. 4, operation 410). The recipient's computing device 150b may transmit the input 306 provided by the recipient 116 to the payment service 112, which may attempt to process the payment based on the input 306 provided by the recipient 116. The payment service 112 may, for example, use a third party credit card processing service to process the payment based on the payment information 306.

The payment service 112 may then determine whether the payment was processed successfully (FIG. 4, operation 412). If the payment service 112 determines that the recipient's payment was processed successfully, then the method 400 of FIG. 4 proceeds to operation 414. Otherwise, the method 400 of FIG. 4A terminates, and the payment service 112 (through the computing device 150b) notifies the recipient 116 that the payment and download process cannot proceed, in which case the payment service 112 prevents the recipient 116 from continuing the payment and download process. Alternatively, the recipient 116 may be given one or some limited number of additional opportunities to complete the payment successfully before the method 400 of FIG. 4 terminates.

After receiving the payment from the recipient 116 (or confirmation that the recipient 116 has made payment) the payment service 112 provides payment 308 to the sender 114 (FIG. 4, operation 414). Although the payment 308 is shown in FIG. 3A as being transmitted to the sender's computing device 150a, this is merely an example. Alternatively, for example, the payment service 112 may provide payment to the sender 114 through a mechanism external to the computing device 150a, such as by depositing funds in the sender's bank account or by using an external payment service (such as PayPal), in which case element 308 may be a notification of the payment rather than a payment itself. For ease of explanation, however, element 308 will be referred to herein as the payment itself.

The amount of the payment 308 may, for example, be equal to the amount of the payment made by the recipient 116. In other words, the payment service 112 may pay to the sender the full amount paid by the recipient 116. As another example, the payment service 112 and/or the system 300 more generally may deduct a portion of the payment made by the recipient 116 and provide the deducted portion to one or more other entities. For example, an administrator user 310 may be an individual or organization that maintains or otherwise administers the system 300 on behalf of the sender 114, recipient 116, and other users. The payment service 112 may provide the deducted portion 312 of the recipient's payment to the administrator user 310, in which case the payment 308 to the sender 114 may be equal to the payment received from the recipient 116 minus the deducted portion 312 of the recipient's payment.

As another example, if there are multiple sending users, then the payment received from the recipient 116 may be divided among the multiple senders (after deducting the deducted portion 312, if any, from the recipient's payment) in any of a variety of ways. For example, the payment service 112 may divide the recipient's payment into equal shares and provide those shares to the senders. As another example, the senders may agree upon each sender's share, in which the amount of the shares may differ from sender to sender. Data representing this apportionment of shares may be stored in the package definition data 120 and then in the corresponding package record 136a. The payment service 112 may then use this apportionment data to divide the recipient's payment into the specified portions for the senders and then to provide the payment portions to the senders in the correct amounts.

The amount 312 that is deducted from the recipient's payment may be calculated in any of a variety of ways. For example, the deduction may be calculated as a percentage of the recipient's payment, as a flat fee independent of the recipient's payment, or as a flat fee plus a percentage of the recipient's payment.

In various embodiments described above, the payment service 112 deducts a certain amount from the recipient's payment and then provides the remainder of the payment to the sender(s). Alternatively, for example, the payment server 112 may provide the full amount of the recipient's payment to the sender(s), in which case the sender(s) may be notified that they are required to make a payment to a third party (such as the administrator of the secure file transfer system 300) in exchange for receipt of the payment. In this case, the sender(s) may subsequently make any such required payment using any means.

The payment service 112 may inform the delivery server 162 that the recipient 116 has made the requirement payment. In response, the delivery server 162 may authorize the envelope 186a to be made available to the recipient 116 (FIG. 4, operation 416). As a result, the delivery server 162 may either transmit the envelope 316 (e.g., envelope 186a) to the recipient 116 automatically, or wait until the recipient 116 provides an envelope request 314 to the delivery server 162 (FIG. 4, operation 418), in response to which the delivery server 162 may transmit the envelope 316 to the recipient 116 (FIG. 4, operation 420). The delivery server 162 may transmit the envelope 316 to the recipient 116 securely, such as by Secure Socket Layer (SSL).

If the envelope 316 is transmitted to the recipient 116 automatically, such transmission may be achieved in any of a variety of ways. For example, the delivery server 162 may push the envelope 316 to the recipient 116 automatically. Alternatively, for example, the recipient 116 may pull the envelope 316 from the delivery server 162 automatically. For example, the package client 152b and/or other component of the recipient's computing device 150b may poll the delivery server 162 for the receipt of envelopes addressed to the recipient 116. Upon detecting any such envelopes, the recipient's computing device 150b may automatically download such envelopes.

Once the recipient 116 has successfully downloaded the envelope 316, the delivery server 162 may transmit a download confirmation message 318 to the sender 114 (FIG. 4, operation 422). The delivery server 162 may also store a record of the download, such as by storing a record of the download in the record of the envelope in the envelope store 182.

The recipient 116 may transmit the envelope request 314 to the delivery server 162 at any time. Therefore, there may be a delay between the time at which the sender 114 uploads the envelope 316 to the delivery server 162 and the time at which the recipient 116 downloads the envelope 316 from the delivery server 162. The sender 114 may change the contents of the package corresponding to the envelope 316 after the sender 114 initially uploads the envelope 316 and before the recipient 116 downloads the envelope 316, such as by adding, removing, or modifying files within the corresponding package. More generally, any sender of the envelope 316 with sufficient privileges may modify the contents of the corresponding package at any time. When the recipient 116 downloads the envelope 316 from the delivery server 162, the delivery server 162 provides to the recipient 116 the contents of the corresponding package as they exist at the time of the download, even if such contents differ from the originally-uploaded contents of the corresponding package.

As another example, the recipient 116 may download the envelope 316 multiple times. The sender 114 may change the contents of the corresponding package between downloads of the envelope 316 by the recipient 116. More generally, any sender of the envelope 316 with sufficient privileges may modify the contents of the corresponding package at any time. Each time the recipient 116 downloads the envelope 316 from the delivery server 162, the delivery server 162 provides to the recipient 116 the contents of the package corresponding to the envelope 316 as they exist at the time of that particular download, even if such contents differ from the contents of the package at the time of the previous download of the envelope 316 by the recipient 116.

As described above, the system 300 may allow the recipient 116 to download the envelope 316 multiple times (in which case the contents of the envelope 316 may remain unchanged or change from download to download). Alternatively, for example, the system 300 may only permit the recipient to download the envelope 316 once, or some limited number of times. The maximum number of permitted downloads may be the same for all envelopes in the system 300, or may vary from envelope to envelope. For example, the package definition data 120 and/or the package data in the package store 132 (e.g., package data 136a) may specify a maximum number of downloads for the corresponding package. As a result, the maximum number of permitted downloads for one package may differ from the maximum number of permitted downloads for another package. The sender 114 may provide input specifying the maximum number of permitted downloads of the package 136a. If the recipient 116 attempts to download the package 136a more than the maximum permitted number of times, the system 300 may prevent the recipient 116 from downloading the package 136a.

As mentioned above, an envelope may have multiple recipients, in which case the maximum permitted number of downloads for the envelope (if any) may be applied per recipient or across all recipients of the envelope in aggregate. For example, in one embodiment, if a particular envelope is permitted to be downloaded no more than ten times, then the system 300 may allow each of multiple recipients of the envelope to download the envelope up to ten times, in which case the envelope may be downloaded more than ten times by all recipients in aggregate. In another embodiment, if a particular envelope is permitted to be downloaded no more than ten times, then the system 300 may only permit the envelope to be downloaded a total of ten times by all recipients of the envelope, in which case the number of times that each recipient is allowed to download the envelope may be less than ten, depending on the number of times the envelope is downloaded by other recipients of the envelope.

In the examples described above, an envelope requires a single payment, regardless of the number of times the envelope is downloaded. This is merely an example, however, and does not constitute a limitation of the present invention. Alternatively, for example, an envelope may require a separate payment for each download of the envelope by any recipient. For example, the envelope definition data 170 and/or the envelope data in the envelope store 182 (e.g., envelope data 186a) may specify a whether a single payment applies to all downloads of the corresponding envelope, or whether a separate payment is required for each download of the envelope. If a separate payment is required for each download, then the system 300 may perform operations 408-416 each time the recipient 116 (or any recipient) attempts to download the envelope 316 so that the system 300 only makes the envelope 316 available for download by the recipient 116 if the recipient 116 successfully makes payment for that download.

As another example, consider a case in which an envelope contains one document and is associated with a first payment amount, such as one dollar. Now assume that a first recipient pays the first payment amount and downloads the envelope. In some embodiments of the present invention, the first recipient may download the envelope additional times without paying any additional amount. Now assume that the sender(s) of the envelope adds one or more documents to the same envelope and changes (e.g., increases) the payment amount for that envelope to a second payment amount (e.g., three dollars). If the first recipient then attempts to download the modified envelope (or the new documents within the modified envelope), the system may charge the first recipient the difference (e.g., two dollars) between the current fee for the envelope (e.g., three dollars) and the amount previously paid by the first recipient for the same envelope (e.g., one dollar). If, however, a second recipient who never downloaded the original envelope and who therefore never paid any fee for the envelope now attempts to download the envelope, the system may charge the second recipient the new (full) amount to download the envelope (e.g., three dollars).

The initial notification message 118 provided by the payment service 112 to the recipient 116 may be treated by the system 300 as if it included the request 314 from the recipient 116 to download the package 136. In this case, the recipient 116 need not provide the request 314 for the envelope 316 to the system 300. Instead, the recipient 116 may simply follow the instructions in the notification message 118 and make the required payment as described above, in response to which the system 300 may transmit the envelope 316 to the recipient 116.

As described above, the envelope 316 may have associated availability data 184. The system 300 may apply the availability data 184 not only at the time at which the recipient 116 responds to the notification 118, but more generally at any time at which the recipient 116 provides a request to download the envelope 316. As a result, for example, the recipient 116 may make a first request to download the envelope 316 before the envelope 316 has expired, in response to which the delivery server 162 may provide the envelope 316 to the recipient 116 in response to the first request. The recipient 116 may then make a second request to download the envelope 316 after the envelope 316 has expired, in response to which the delivery server 162 may refuse to provide the envelope 316 to the recipient 116 in response to the second request.

Embodiments of the present invention have a variety of advantages. For example, embodiments of the present invention enable files to be transferred easily and securely over the Internet or other network. Senders may use a web-based interface to upload files for transmission to recipients. Recipients may also use a web-based interface to download the uploaded files. Both senders and recipients may therefore avoid the various disadvantages of email, FTP, and other traditional file transfer methods. For example, embodiments of the present invention may be used to transfer files of any size, unlike email. As another example, embodiments of the present invention may be used to transfer files securely, unlike traditional FTP. As yet another example, embodiments of the present invention may provide a user interface that is easy for novice users to understand and use, thereby encouraging and facilitating its use by a wide variety of users.

Another advantage of embodiments of the present invention is that they may be used to require recipients to pay to receive envelopes from senders. For example, a sender may specify a payment amount for a particular envelope. The recipient of the envelope may then be required to make the required payment before they are allowed to download the envelope. Embodiments of the present invention may collect the required payment from the recipient and provide the payment to the sender. In this way, embodiments of the present invention provide a simple mechanism for enabling senders to sell content over the Internet securely. In contrast, traditional file transfer methods, such as email and FTP, do not provide any ability to require recipients to pay for transferred content or to process such payments.

Another advantage of embodiments of the present invention is that they enable entities that facilitate envelope transmission to be paid a commission for such facilitation in the form of a portion of the payment made by recipient to sender for transmission of a envelope. Such a payment may take any of a variety of forms. Because such payment may be deducted automatically by the system and the remainder paid to the sender, embodiments of the present invention may facilitate business models in which one entity facilitates the transmission of electronic envelopes from one party to another in exchange for payment. Different senders associated with the same envelope may be charged the same or different commissions as each other.

In addition to or instead of the commission per transaction described above, embodiments of the present invention may charge a sender a fee of any kind for uploading a package to the system, whether or not any recipients download such a package. This feature provides providers of the secure file transfer system with flexibility in pricing.

Another advantage of embodiments of the present invention is that they may be used to require a payment from an envelope recipient each time the recipient downloads the envelope. As a result, embodiments of the present invention may be used to enable senders to generate revenue each time a recipient downloads an envelope.

Another advantage of embodiments of the present invention is that they may be used to facilitate transmission of packages from multiple senders. Any of the multiple senders associated with a package may add, delete, or modify content within the package at any time. The system may divide the payment made by the recipient among the multiple senders in any of a variety of ways. In this way, embodiments of the present invention facilitate sharing of revenue among multiple senders and thereby encourage collaboration and cooperation among senders.

Another advantage of embodiments of the present invention is that they may be used to facilitate transmission of envelopes to multiple recipients. Any of the recipients associated with an envelope may download the envelope at any time. Payment may be required and collected from each recipient. As a result, embodiments of the present invention may be used to facilitate the sale of a single package to multiple recipients and to increase the revenue generated from such sales.

A related benefit of embodiments of the present invention is that different access control rights may be associated with different recipients of the same envelope. Such access control rights may be associated with the entire envelope or separately with different components of the envelope (such as the secure message 178 and file 128). For example, in one embodiment, a first recipient may have read-only rights to a particular envelope, while a second recipient may have both read and write rights to the same envelope, in which case such rights may apply to all contents of the envelope. In another embodiment, a first recipient may have read-only rights to the secure message 178 in a envelope but have read and write rights to the file 128 in the same envelope. In yet another embodiment, in which the file 128 in a envelope includes multiple files, a first recipient may have read-only rights to one of the files but read and write rights to another one of the files in the same envelope. The ability to grant different access control rights to different users at any level of granularity provides creators and users of envelopes with a significant degree of flexibility.

A related advantage of embodiments of the present invention is that a sender may, at any time, add or remove recipients to the set of recipients who are associated with a particular envelope. For example, the sender may initially create an envelope and associate no recipients with it. The sender may then associate a first recipient with the envelope (e.g., in response to an expression of interest by the recipient or the signing of a contract by the recipient). The sender may then associate a second and additional recipients with the envelope. Any new recipient is required to make a required payment or payments as described herein. The sender may remove any recipient from the envelope at any time. For example, if a recipient violates the terms of service associated with a envelope or the recipient's contract with the sender expires, the sender may remove the recipient from the set of recipients associated with the envelope. This features facilitates the use of embodiments of the present invention for commercial transactions between a sender and multiple recipients without requiring the sender to generate a separate envelope for each recipient (assuming that the same envelope is desired to be made available to each recipient).

A related advantage of embodiments of the present invention is that they enable senders to specify the recipient(s) who are entitled to purchase the package, and that they both enable the specified recipient(s) to purchase the package and prevent anyone other than the specified recipient(s) from purchasing the package. In particular, if a user who is not in the set of recipients associated with a package attempts to pay for or download the package, embodiments of the present invention will prevent such a user from paying for, downloading, or otherwise accessing the package. In this way, embodiments of the present invention enable the creation of closed marketplaces controlled by the sender(s), in contrast to open marketplaces such as Amazon and eBay, in which any purchaser may view, purchase, and obtain items offered for sale.

Senders may associate different payment amounts with different recipients of the same envelope. For example, a sender may associate a first payment amount with a first recipient of an envelope and associate a different payment amount with a second recipient of the same envelope. As a result, embodiments of the present invention enable senders to engage in differential pricing of electronic content for different users or market segments.

The system may enforce minimum and/or maximum payment amounts on senders. For example, a particular organization may enforce minimum and/or maximum payment amounts on the payment amounts that senders within that organization associate with envelopes that they send. A minimum price requirement may be useful, for example, if the organization wants to ensure that some minimum amount of revenue or profit is generated per downloaded envelope. A maximum price requirement may be useful, for example, if the organization wants to avoid pricing any of its content beyond a point that is known or believed to be competitive.

If an envelope has multiple owners, payment for the download of a envelope may be divided among the multiple owners in any of a variety of ways. For example, payment may be divided equally or unequally among the owners. The division of payment among the owners may be specified and agreed upon by one, some, or all of the owners. As a result, embodiments of the present invention facilitate sharing of revenue among owners, and encourage revenue sharing in cases in which different owners provide contributions of varying value to the same package.

Another advantage of embodiments of the present invention is that an expiration date may be associated with an envelope. The system may prevent recipients from downloading the envelope after the envelope's expiration date. Similarly, an availability date may be associated with an envelope. The system may prevent recipients from downloading the envelope before the envelope's availability date. An envelope may have both an expiration date and an availability date. As a result, embodiments of the present invention may provide senders with control over the times during which recipients may download the envelope. The expiration date and/or availability date associated with an envelope may apply to all users (senders and recipients) of that envelope. Alternatively, for example, different expiration dates and/or availability dates may be associated with different users of the same envelope. For example, a first expiration date may apply to a first recipient of a particular envelope, while a second, different, expiration date may apply to a second recipient of the same envelope. This ability to associate expiration dates and availability dates with users at any level of granularity provides senders of envelopes with a significant degree of control over the availability of those envelopes to recipients.

Once an envelope has been delivered to a recipient, the sender(s) of the envelope may be notified of the successful transmission. This enables senders to keep track of the transmission of their envelopes. Furthermore, the system may record each successful envelope transmission by the system. As a result, the system may enable senders and/or recipients to generate reports of transmission activity. For example, the system may enable a sender to generate a report of all of the sender's envelopes that have been downloaded by recipients, of the total revenue generated by the system for the sender in aggregate across all envelopes, or of the revenue generated by the system for the sender for each of the sender's envelopes.

Yet another benefit of embodiments of the present invention is that they need not require that recipients of envelopes be enrolled as users of the system. For example, in certain embodiments of the present invention, a sender may be required to be enrolled as a user of the system, but such a sender may use the system to transmit envelopes securely to a recipient who is not enrolled as a user of the system, and to require payment from such a recipient. In this case, the system may, for example, notify the recipient of the availability of the envelope by transmitting an email message to the recipient. The recipient may take action in response to the email message, such as by following a link in the email message to the payment service and then perform the other steps described herein. As a result, the system may obtain payment from the recipient and enable the recipient to download the envelope even though the recipient is not enrolled as a user of the system. Similarly, the recipient need not have any special software installed on his or her computing device to pay for and download the envelope. This feature may be used to enable the system to be used to transmit electronic envelopes to (and obtain payment from) a wider range of recipients than would be possible if all recipients were required to be enrolled as users of the system.

Yet another benefit of embodiments of the present invention is that they enable senders to transmit confidential messages to recipients through the use of the message 178 section of the envelope definition data 170. This confidential, secure, message is made accessible to each recipient only after that recipient has been authenticated. If authentication of the recipient fails, then the confidential message 178 remains inaccessible to the recipient. As a result, senders can put information in the secure message that must satisfy security requirements, such as those imposed by state and/or federal privacy laws (e.g., HIPPA, 201 CMR §17).

Another advantage of embodiments of the present invention is that they may be used to automate various aspects of the secure file transfer process. For example, in one embodiment of the present invention, a particular package may be associated with a folder in the file system of the package sender's local computer. If the sender (or more generally, any sender of the package if the package has multiple senders) moves or copies a file into the folder associated with the package, embodiments of the present invention may detect that a file has been received into the folder, and automatically transit the file to the recipient(s) of the package using the techniques disclosed herein.

Yet another advantage of embodiments of the present invention is that they may provide interfaces for interacting with external systems (such as external computer hardware and/or software). Examples of such interfaces include web services interfaces and application program interfaces (APIs). External systems may issue commands to embodiments of the present invention through such APIs to cause embodiments of the present invention to perform any of the functions disclosed herein, such as creating packages, changing access control rights associated with senders and/or recipients, and delivering packages. This feature makes embodiments of the present invention useful not only to end users but also to creators and administrators of other systems who wish to provide secure file transfer functionality to end users of those other systems.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

Although the package definition data 120 (FIG. 1A) and envelope definition data 170 (FIG. 1B) are shown herein as separate data structures, some or all of such structures may be combined together. The term “electronic transmission data” is used herein to refer generically to some or all of the package definition data 120, some or all of the envelope definition data 170, or any combination thereof. As used herein, both electronic packages and electronic envelopes are examples of “electronic transmissions.”

Although various components are referred to herein as “clients” and “servers,” such terms are used merely as examples and do not constitute limitations of the present invention. Such components may, for example, be implemented in other ways that may not be characterized as “clients” or “servers” and that may not operate in systems having a client-server architecture.

Although the package clients 152a-b are illustrated as distinct components within the computing devices 150a-b, this is merely an example and does not constitute a limitation of the present invention. For example, package client 152a may be a plug-in, add-on, or other modification to a software application such as a web browser, email client, or mobile app. As a result, any such software with an installed plug-in may perform the functions of the package client 152a described herein.

Although the description herein states that the sender may provide one set of package definition data 120 at a time, this is merely an example and does not constitute a limitation of the present invention. Alternatively, for example, the sender may provide a plurality of sets of package definition data 120 simultaneously, such as by including them in a file (e.g., a comma-delimited or tab-delimited file), database table, or other data structure that is transmitted to the package server 102. The package server 102 may then process all of the sets of package definition data automatically using the techniques disclosed herein, thereby avoiding the need for the sender 114 to provide each set of package definition data 120 separately.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method comprising:
(A) receiving, from a first sender, electronic transmission definition data representing an original electronic transmission, the electronic transmission definition data comprising:
(A)(1) a first recipient identifier specifying a first recipient of the original electronic transmission;
(A)(2) original message data; and
(A)(3) first payment data representing a first required payment amount;
(B) receiving, from the first recipient, first payment data;
(C) attempting to obtain, based on the first payment data, a first payment in an amount equal to the first required payment amount; and
(D) making the original message data available to the first recipient only if the attempt to obtain the first payment from the first recipient succeeds.

2. The method of claim 1, further comprising:
(E) receiving, from a user other than the first recipient, a request for the original message data; and
(F) denying the request.

3. The method of claim 1, wherein (B) comprises:
(B)(1) transmitting a notification message to the first recipient;
(B)(2) receiving the first payment data from the first recipient in response to the notification message.

4. The method of claim 3, wherein the notification message comprises an email message.

5. The method of claim 1, wherein the original message data comprises text.

6. The method of claim 1, wherein the original message data comprises a file.

7. The method of claim 6, wherein the original message data comprises a plurality of files.

8. The method of claim 1, wherein (B) comprises:
(B)(1) determining whether an expiration time associated with the original electronic transmission has passed;
(B)(2) prompting the first recipient for the first payment data in response to determining that the expiration time has not passed; and
(B)(3) receiving the first payment data from the first recipient in response to the prompt.

9. The method of claim 1, wherein (B) comprises:
(B)(1) determining whether an availability time associated with the original electronic transmission has passed;
(B)(2) prompting the first recipient for the first payment data in response to determining that the availability time has passed; and
(B)(3) receiving the first payment data from the first recipient in response to the prompt.

10. The method of claim 1, wherein (A) comprises receiving the electronic transmission definition data from a plurality of senders, wherein the plurality of senders includes the first sender.

11. The method of claim 1, further comprising:
(E) making a second payment to the first sender in an amount based on the first required payment amount.

12. The method of claim 11, wherein (E) comprises making the second payment to the sender in an amount equal to the first required payment amount.

13. The method of claim 11, wherein (E) comprises:
(E)(1) deducting a portion of the first payment in an amount less than the first required payment amount;
(E)(2) making a third payment to a party other than the first sender and the first recipient in the amount of the deducted portion; and
(E)(3) making the second payment to the sender, wherein the amount of the second payment is equal to the amount of the first payment minus the amount of the deducted portion.

14. The method of claim 1, wherein the electronic transmission definition data comprises a plurality of recipient identifiers specifying a plurality of recipients of the original electronic package, wherein the plurality of recipient identifiers comprises the first recipient identifier.

15. The method of claim 14, further comprising:
(B) receiving, from the a second recipient specified by a second recipient identifier within the plurality of recipient identifiers, second payment data;
(C) attempting to obtain, based on the second payment data, a second payment in an amount equal to the first required payment amount; and
(D) making the original message data available to the second recipient only if the attempt to obtain the second payment from the second recipient succeeds.

16. The method of claim 14:
wherein the electronic transmission definition data further comprises second payment data representing a second required payment amount, wherein the first required payment amount differs from the second required payment amount, and wherein the method further comprises:
(B) receiving, from the a second recipient specified by a second recipient identifier within the plurality of recipient identifiers, second payment data;
(C) attempting to obtain, based on the second payment data, a second payment in an amount equal to the second required payment amount; and
(D) making the original message data available to the second recipient only if the attempt to obtain the second payment from the second recipient succeeds.

17. The method of claim 1, further comprising:
(E) receiving a request from the first recipient to obtain the original message data; and
(F) providing the original message data to the first recipient in response to the request, without requiring a second payment from the first recipient.

18. The method of claim 1, further comprising:
(E) receiving a request from the first recipient to obtain the original message data;
(F) receiving, from the first recipient, second payment data representing a second required payment amount, wherein the first required payment amount differs from the second required payment amount;
(G) attempting to obtain, based on the second payment data, a second payment in an amount equal to the first required payment amount; and
(H) making the original message data available to the first recipient only if the attempt to obtain the second payment from the first recipient succeeds.

19. The method of claim 1, further comprising:
(E) modifying the original message data in the electronic transmission to produce modified message data;
(E) receiving a request from the first recipient to obtain the electronic transmission; and
(F) providing the modified message data to the first recipient in response to the request.

20. The method of claim 1, further comprising:
(E) providing the original message data to the first recipient securely.

21. The method of claim 20, wherein (E) comprises transmitting the original message data to the first recipient using Secure Socket Layer (SSL).

22. The method of claim 20, wherein (E) comprises transmitting the original message data to the first recipient using HTTPS.

23. A non-transitory computer-readable medium having computer program instructions stored thereon, wherein the computer program instructions are executable by at least one computer processor to perform a method comprising:
(A) receiving, from a first sender, electronic transmission definition data representing an original electronic transmission, the electronic transmission definition data comprising:
(A)(1) a first recipient identifier specifying a first recipient of the original electronic transmission;
(A)(2) original message data; and
(A)(3) first payment data representing a first required payment amount;
(B) receiving, from the first recipient, first payment data;
(C) attempting to obtain, based on the first payment data, a first payment in an amount equal to the first required payment amount; and
(D) making the original message data available to the first recipient only if the attempt to obtain the first payment from the first recipient succeeds.

24. The computer-readable medium of claim 23, further comprising:
(E) receiving, from a user other than the first recipient, a request for the original message data; and
(F) denying the request.

25. The computer-readable medium of claim 23, wherein (B) comprises:
(B)(1) transmitting a notification message to the first recipient;
(B)(2) receiving the first payment data from the first recipient in response to the notification message.

26. The computer-readable medium of claim 25, wherein the notification message comprises an email message.

27. The computer-readable medium of claim 23, wherein the original message data comprises text.

28. The computer-readable medium of claim 23, wherein the original message data comprises a file.

29. The computer-readable medium of claim 28, wherein the original message data comprises a plurality of files.

30. The computer-readable medium of claim 23, wherein (B) comprises:
(B)(1) determining whether an expiration time associated with the original electronic transmission has passed;
(B)(2) prompting the first recipient for the first payment data in response to determining that the expiration time has not passed; and
(B)(3) receiving the first payment data from the first recipient in response to the prompt.

31. The computer-readable medium of claim 23, wherein (B) comprises:
(B)(1) determining whether an availability time associated with the original electronic transmission has passed;
(B)(2) prompting the first recipient for the first payment data in response to determining that the availability time has passed; and
(B)(3) receiving the first payment data from the first recipient in response to the prompt.

32. The computer-readable medium of claim 23, wherein (A) comprises receiving the electronic transmission definition data from a plurality of senders, wherein the plurality of senders includes the first sender.

33. The computer-readable medium of claim 23, further comprising:
(E) making a second payment to the first sender in an amount based on the first required payment amount.

34. The computer-readable medium of claim 33, wherein (E) comprises making the second payment to the sender in an amount equal to the first required payment amount.

35. The computer-readable medium of claim 33, wherein (E) comprises:
(E)(1) deducting a portion of the first payment in an amount less than the first required payment amount;
(E)(2) making a third payment to a party other than the first sender and the first recipient in the amount of the deducted portion; and
(E)(3) making the second payment to the sender, wherein the amount of the second payment is equal to the amount of the first payment minus the amount of the deducted portion.

36. The computer-readable medium of claim 23, wherein the electronic transmission definition data comprises a plurality of recipient identifiers specifying a plurality of recipients of the original electronic package, wherein the plurality of recipient identifiers comprises the first recipient identifier.

37. The computer-readable medium of claim 36, further comprising:
(B) receiving, from the a second recipient specified by a second recipient identifier within the plurality of recipient identifiers, second payment data;
(C) attempting to obtain, based on the second payment data, a second payment in an amount equal to the first required payment amount; and
(D) making the original message data available to the second recipient only if the attempt to obtain the second payment from the second recipient succeeds.

38. The computer-readable medium of claim 36:
wherein the electronic transmission definition data further comprises second payment data representing a second required payment amount, wherein the first required payment amount differs from the second required payment amount, and wherein the method further comprises:
(B) receiving, from the a second recipient specified by a second recipient identifier within the plurality of recipient identifiers, second payment data;
(C) attempting to obtain, based on the second payment data, a second payment in an amount equal to the second required payment amount; and
(D) making the original message data available to the second recipient only if the attempt to obtain the second payment from the second recipient succeeds.

39. The computer-readable medium of claim 23, further comprising:
(E) receiving a request from the first recipient to obtain the original message data; and
(F) providing the original message data to the first recipient in response to the request, without requiring a second payment from the first recipient.

40. The computer-readable medium of claim 23, further comprising:
(E) receiving a request from the first recipient to obtain the original message data;
(F) receiving, from the first recipient, second payment data representing a second required payment amount, wherein the first required payment amount differs from the second required payment amount;
(G) attempting to obtain, based on the second payment data, a second payment in an amount equal to the first required payment amount; and
(H) making the original message data available to the first recipient only if the attempt to obtain the second payment from the first recipient succeeds.

41. The computer-readable medium of claim 23, further comprising:
(E) modifying the original message data in the electronic transmission to produce modified message data;
(E) receiving a request from the first recipient to obtain the electronic transmission; and
(F) providing the modified message data to the first recipient in response to the request.

42. The computer-readable medium of claim 23, further comprising:
(E) providing the original message data to the first recipient securely.

43. The computer-readable medium of claim 42, wherein (E) comprises transmitting the original message data to the first recipient using Secure Socket Layer (SSL).

44. The computer-readable medium of claim 42, wherein (E) comprises transmitting the original message data to the first recipient using HTTPS.
